(19) United States
(12) Patent Application Publication
(10) Pub. No.: US 2015/0277252 A1
(43) Pub. Date: Oct. 1, 2015

(54) BRILLIANT TONER, ELECTROSTATIC CHARGE IMAGE DEVELOPER, TONER CARTRIDGE, AND PROCESS CARTRIDGE

(71) Applicant: FUJI XEROX CO., LTD., Tokyo (JP)

(72) Inventors: Masaru TAKAHASHI, Kanagawa (JP); Satomi HARA, Kanagawa (JP); Sakiko HIRAI, Kanagawa (JP); Shotaro TAKAHASHI, Kanagawa (JP); Atsushi SUGITATE, Kanagawa (JP)

(21) Appl. No.: 14/468,828

(22) Filed: Aug. 26, 2014

(30) Foreign Application Priority Data
Mar. 25, 2014 (JP) 2014-062756

(51) Int. Cl. G03G 9/08; G03G 9/087

(52) U.S. Cl. CPC G03G 9/0823; G03G 9/08706; G03G 9/0825; G03G 9/0819

(57) ABSTRACT

A brilliant toner includes toner particles containing a binder resin, a brilliant pigment, and particles selected from hollow particles and porous particles, wherein a relative dielectric constant of the toner particles is from 2.0 to 6.0.

### CROSS-REFERENCE TO RELATED APPLICATIONS

This application is based on and claims priority under 35 USC 119 from Japanese Patent Application No. 2014-062756 filed Mar. 25, 2014.

### BACKGROUND

### Technical Field

The present invention relates to a brilliant toner, an electrostatic charge image developer, a toner cartridge, and a process cartridge.

### SUMMARY

According to an aspect of the invention, there is provided a brilliant toner including:

toner particles containing a binder resin, a brilliant pigment, and particles selected from hollow particles and porous particles,

wherein a relative dielectric constant of the toner particles is from 2.0 to 6.0.

### BRIEF DESCRIPTION OF THE DRAWINGS

Exemplary embodiments of the present invention will be described in detail based on the following figures, wherein:

FIG. 1 is a cross-sectional view schematically showing an example of brilliant toner particles of an exemplary embodiment;

FIG. 2 is a schematic configuration diagram showing an example of an image forming apparatus of an exemplary embodiment; and

FIG. 3 is a schematic configuration diagram showing an example of a process cartridge of the exemplary embodiment.

### DETAILED DESCRIPTION

Hereinafter, exemplary embodiments of a brilliant toner, an electrostatic charge image developer, a toner cartridge, a process cartridge, an image forming apparatus, and an image forming method of the invention will be described in detail.

Brilliant Toner

The brilliant toner of the exemplary embodiment (hereinafter, referred to as “toner” in some cases) includes toner particles containing a binder resin, a brilliant pigment, and particles selected from hollow particles and porous particles, in which a relative dielectric constant of the toner particles is from 2.0 to 6.0.

Herein, in the related art, metal or an inorganic material such as metal oxide is frequently used as the brilliant pigment of the brilliant toner. Accordingly, the relative dielectric constant of the toner particles containing the brilliant pigment increases as compared to a case of including a colorant of the related art. When the relative dielectric constant of the toner particles increases, an electrical field in a periphery portion thereof is alleviated, and accordingly, a force for holding the toner on a recording medium or an intermediate transfer member may decrease. Thus, the toner may be scattered from an image portion to a non-image portion on a recording medium or an intermediate transfer member, due to an electrostatic external influence in an image forming step.

This phenomenon easily and significantly occurs, for example, in a case where a processing speed is high (in a case where a recording medium feeding speed is equal to or higher than 400 mm/s, for example) and thus susceptibility to the electrostatic external influence is enhanced, in a case where a charging ability of the brilliant toner easily decreases in the environment with a high temperature and high humidity, and in a case where a brilliant toner layer is overlapped on an upper layer of a color toner layer having some thickness and an electrostatic force with respect to the recording medium or the intermediate transfer member decreases.

Herein, the brilliant toner according to the exemplary embodiment decreases the relative dielectric constant of the toner particles containing the brilliant pigment to the range described above. Accordingly, the alleviation of the electrical field in a periphery portion is prevented by the toner itself, and a force for holding the toner on the recording medium or the intermediate transfer member is increased.

Therefore, in the brilliant toner according to the exemplary embodiment, the scattering of the brilliant toner (hereinafter, also referred to as “toner scattering”) from the image portion to the non-image portion is prevented.

Herein, in the brilliant toner according to the exemplary embodiment, the relative dielectric constant of the toner particles is preferably from 3.0 to 5.5 and is more preferably from 4.0 to 5.0, from a viewpoint of the prevention of the toner scattering.

In order to adjust the relative dielectric constant of the toner particles, a method of causing at least one of hollow particles and porous particles to be contained in the toner particles and causing air having a low relative dielectric constant to exist in the toner particles is used, for example.

The relative dielectric constant of the toner particles is a value measured with the following method.

The toner particles are subjected to pressure molding at 98067 KPa (1000 Kgf/cm²) for 1 minute, so as to have a disk shape with a diameter of 50 mm and a thickness of 3 mm. The toner particles are left in the atmosphere with a temperature of 30° C. and relative humidity of 90% for 24 hours, and then the relative dielectric constant is measured. In the measurement, the toner particles are set in an electrode for solid (SE-71 manufactured by Ando Electric Co., Ltd.) having an electrode diameter of 38 mm and the measurement is performed under the applying voltage conditions of 0.1 Hz and 5 V, by using a dielectric measurement system (126096W manufactured by Solartron Ltd).

In a case where an external additive is externally added to the toner particles, for example, the toner is dispersed in ion exchange water to which a dispersant such as a surfactant is added, and the external additive and the toner particles are separated from each other by applying an ultrasonic wave with an ultrasonic homogenizer (US-300T manufactured by NISSEI Corporation). After that, only the toner particles are extracted by a filtrating process and a washing process, and the obtained toner particles are used.

However, since, as long as a general externally added amount of the external additive is used, there is no practical fluctuation of the measured values between relative dielectric constants of the toner particles to which the external additive is not externally added and the toner particles to which the external additive is externally added, and thus the toner particles to which the external additive is externally added may be used as a measurement target.

The “brilliance” in the toner according to the exemplary embodiment means that brilliance such as metallic gloss is seen when an image formed with the brilliant toner of the exemplary embodiment is visually observed.

In detail, as the brilliant toner, toner in which a ratio (A/B) of a reflectance A at a light receiving angle of +30° and a reflectance B at a light receiving angle of −30°, measured in the case of forming of a solid image which is irradiated with incident light at an angle of incidence of −45° by a goniophotometer, is from 2 to 100.

The value of the ratio (A/B) which is equal to or greater than 2 represents that the reflection at the side opposite the incident light (positive angle side) is greater than the reflection at the side of the incident light (negative angle side) and diffuse reflection of the incident light is prevented. In a case where the diffuse reflection that incident light is reflected to various directions occurs, the color appears to be darkened when visually observing the reflected light thereof. Accordingly, when the ratio (A/B) is equal to or greater than 2, the gloss is confirmed and the excellent brilliance is obtained when visually observing the reflected light thereof.

Meanwhile, if the ratio (A/B) is equal to or less than 100, a visible angle with which the reflected light can visually observed is not excessively narrow, and accordingly, a phenomenon in which the color appears to be black by an angle is unlikely to occur.

The ratio (A/B) described above is more preferably from 20 to 90 and particularly preferably from 40 to 80.

### Measurement of Ratio (A/B) With Goniophotometer

Herein, first the angle of incidence and the light receiving angle will be described. When measuring the ratio with the goniophotometer in the exemplary embodiment, the angle of incidence is set to −45°, and this is because high measurement sensitivity is obtained with respect to an image with a wide range of glossiness.

In addition, the light receiving angle is set to −30° and to +30° because the measurement sensitivity is highest when evaluating an image with brilliance and an image with no brilliance.

Next, a method of measuring the ratio (A/B) will be described.

In the exemplary embodiment, when measuring the ratio (A/B), first, a “solid image” is formed with the following method. A developing device of a DocuCentre-III C7600 manufactured by Fuji Xerox Co. , Ltd. is filled with a developer that is a sample, and a solid image having a toner applied amount of 4.5 g/cm² is formed on a recording sheet (OK Top Coat+ (plus), manufactured by Oji Paper Co., Ltd.) at a fixing temperature of 190° C. and a fixing pressure of 4.0 kg/cm². The “solid image” indicates an image having coverage rate of 100%.

The incident light at an angle of incidence of −45° with respect to the solid image is applied to an image portion of the formed solid image, and a reflectance A at a light receiving angle of +30° and a reflectance B at a light receiving angle of −30° are measured by using a variable angle photometer GC5000L manufactured by Nippon Denshoku Industries Co., Ltd. as a goniophotometer. Each of the reflectance A and the reflectance B is measured regarding the light having a wavelength of 400 nm to 700 nm at intervals of 20 nm, and defined as an average of the reflectances at respective wavelengths. The ratio (A/B) is calculated from these measurement results.

From the viewpoint of satisfying the above-described ratio (A/B), the brilliant toner according to the exemplary embodiment preferably satisfies the following requirements (1) and (2).

(1) The brilliant toner particles have an average equivalent circle diameter D longer than an average maximum thickness C.

(2) When cross sections of brilliant toner particles in a thickness direction are observed, a rate of a brilliant pigment particles that are present so that an angle between a long axis direction of the toner particles in the cross section and a long axis direction of the brilliant pigment particles is from −30° to +30° is 60% or greater with respect to the total brilliant pigment particles that are observed.

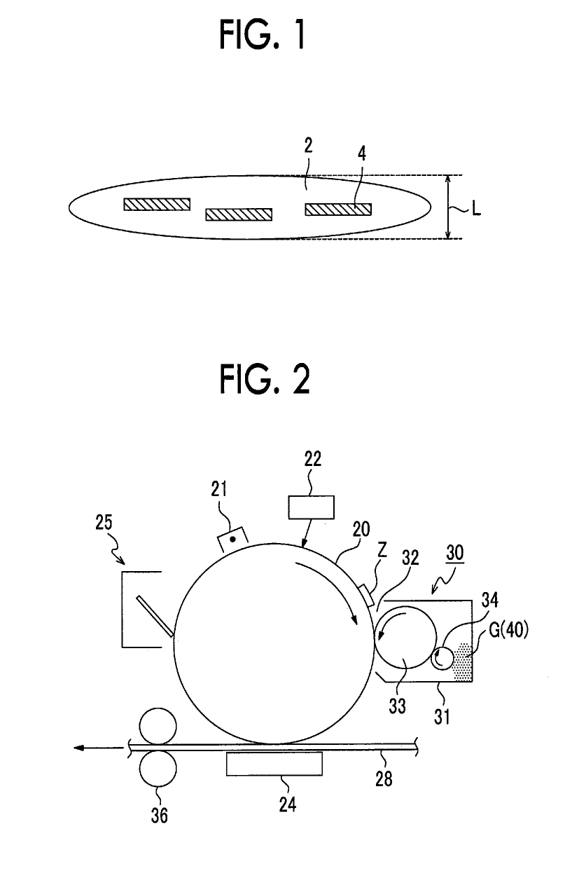

Herein, FIG. 1 is a cross-sectional view schematically showing an example of toner particles satisfying the requirements (1) and (2) described above. The schematic view shown in FIG. 1 is a cross-sectional view of the toner particles in a thickness direction thereof.

A toner particle 2 shown in FIG. 1 is a flake-shape toner particle having a larger equivalent circle diameter than a thickness L, and contains flake-shape brilliant pigment particles 4.

As shown in FIG. 1, in a case where the toner particle 2 has a flake shape having a larger equivalent circle diameter than the thickness L, when the toner particle moves to an image holding member, an intermediate transfer member, or the recording medium in a development step or a transfer step in image forming, the toner particle tends to move so as to eliminate the charge of the toner particles as much as possible, and accordingly it is considered that the toner particles are arranged so as to have the maximum attached area. That is, it is considered that on the recording medium to which the toner particle is finally transferred, the flake-shape toner particles are arranged so that the flat surface side faces the surface of the recording medium. In addition, it is considered that the flake-shape toner particles are arranged so that the flat surface sides thereof face the surface of the recording medium due to the pressure in the fixing step, even in the fixing step of the image forming.

Therefore, it is considered that among the flake-shape brilliant pigment particles contained in the toner particle, brilliant pigment particles that satisfy “an angle between a long axis direction of the toner in the cross section and a long axis direction of the brilliant pigment particles is from −30° to +30°” described in the requirement (2) are arranged so that the surface side that provides the maximum area faces the surface of the recording medium. It is considered that when the image formed in this manner is irradiated with light, the proportion of the brilliant pigment particles that causes diffuse reflection of the incident light is prevented, and thus the above-described range of the ratio (A/B) is achieved.

Hereinafter, the toner according to the exemplary embodiment will be described in detail.

The toner according to the exemplary embodiment contains the toner particles. The toner may contain the external additive, if necessary.

Toner Particles

The toner particles, for example, include the binder resin and the brilliant pigment. The toner particles may contain the hollow particles, the porous particles, and other additives such as a release agent.

Binder Resin

Examples of the binder resin include a homopolymer of a monomer such as styrenes (for example, styrene, p-chlorostyrene, α-methyl styrene, or the like), (meth)acrylic esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, or the like), ethylenic unsaturated nitriles (for example, acrylonitrile, methacrylonitrile, or the like), vinyl ethers (for example, vinyl methyl ether, vinyl isobutyl ether, or the like), vinyl ketones (for example, vinyl methyl ketone, vinyl ethyl ketone, vinyl isopropenyl ketone, or the like), olefins (for example, ethylene, propylene, butadiene, or the like), or a vinyl resin formed of a copolymer obtained by combining two or more kinds of the monomers.

Examples of the binder resin include a non-vinyl resin such as an epoxy resin, a polyester resin, a polyurethane resin, a polyamide resin, a cellulose resin, a polyether resin, and a modified rosin, a mixture of these and the vinyl resin, or a graft polymer obtained by polymerizing the vinyl monomer under coexistence thereof.

These binder resins maybe used alone or in combination with two or more kinds thereof.

As the binder resin, a polyester resin is preferable.

As the polyester resin, a well-known polyester resin is used, for example.

Examples of the polyester resin include condensation polymers of polyvalent carboxylic acids and polyols. A commercially available product or a synthesized product may be used as the polyester resin.

Examples of the polyvalent carboxylic acid include aliphatic dicarboxylic acids (e.g., oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), anhydrides thereof, or lower alkyl esters (having, for example, from 1 to 5 carbon atoms) thereof. Among these, for example, aromatic dicarboxylic acids are preferably used as the polyvalent carboxylic acid.

As the polyvalent carboxylic acid, a tri- or higher-valent carboxylic acid employing a crosslinked structure or a branched structure may be used in combination together with a dicarboxylic acid. Examples of the tri- or higher-valent carboxylic acid include trimellitic acid, pyromellitic acid, anhydrides thereof, or lower alkyl esters (having, for example, from 1 to 5 carbon atoms) thereof.

The polyvalent carboxylic acids may be used alone or in combination of two or more kinds thereof.

Examples of the polyol include aliphatic diols (e.g., ethylene glycol, diethylene glycol, triethylene glycol, propylene glycol, butanediol, hexanediol, and neopentyl glycol), alicyclic dials (e.g., cyclohexanediol, cyclohexanedimethanol, and hydrogenated bisphenol A), and aromatic diols (e.g., ethylene oxide adduct of bisphenol A and propylene oxide adduct of bisphenol A). Among these, for example, aromatic diols and alicyclic diols are preferably used, and aromatic diols are more preferably used as the polyol.

As the polyol, a tri- or higher-valent polyol employing a crosslinked structure or a branched structure may be used in combination together with a diol. Examples of the tri- or higher-valent polyol include glycerin, trimethylolpropane, and pentaerythritol.

The polyols may be used alone or in combination of two or more kinds thereof.

A glass transition temperature (Tg) of the polyester resin is preferably from 50° C. to 80° C., and more preferably from 50° C. to 65° C.

The glass transition temperature is acquired by a DSC curve obtained by differential scanning calorimetry (DSC), and more specifically, is acquired by “extrapolation glass transition starting temperature” disclosed in a method of acquiring the glass transition temperature of JIS K7121−1987 “Testing Methods for Transition Temperature of Plastics”.

A weight average molecular weight (Mw) of the polyester resin is preferably from 5,000 to 1,000,000, and more preferably from 7,000 to 500,000.

The number average molecular weight (Mn) of the polyester resin is preferably from 2,000 to 100,000.

The molecular weight distribution Mw/Mn of the polyester resin is preferably from 1.5 to 100, and more preferably from 2 to 60.

The weight average molecular weight and the number average molecular weight are measured by gel permeation chromatography (GPC). The molecular weight measurement by GPC is performed with a THF solvent using HLC-8120 GPC, which is a GPC manufactured by Tosoh Corporation as a measurement device by using TSKgel Super HM-M (15 cm), which is a column manufactured by Tosoh Corporation. The weight average molecular weight and the number average molecular weight are calculated using a calibration curve of molecular weight created with a monodisperse polystyrene standard sample from results of this measurement.

The polyester resin is obtained with a well-known preparing method. Specific examples thereof include a method of conducting a reaction at a polymerization temperature set to 180° C. to 230° C., if necessary, under reduced pressure in the reaction system, while removing water or an alcohol generated during condensation.

When monomers of the raw materials are not dissolved or compatibilized under a reaction temperature, a high-boiling-point solvent may be added as a solubilizing agent to dissolve the monomers. In this case, a polycondensation reaction is conducted while distilling away the solubilizing agent. When a monomer having poor compatibility is present in a copolymerization reaction, the monomer having poor compatibility and an acid or an alcohol to be polycondensed with the monomer may be previously condensed and then polycondensed with the major component.

The content of the binder resin is preferably from 40% by weight to 95% by weight, more preferably from 50% by weight to 90% by weight, and even more preferably from 60% by weight to 85% by weight, with respect to the entirety of toner particles.

Brilliant Pigment

As the brilliant pigment, for example, a pigment (brilliant pigment) which can applybrilliance such as metallic gloss is used. Specific examples of the brilliant pigment include metal powder such as aluminum (metal of Al simple substance), brass, bronze, nickel, stainless steel, or zinc; mica on which titanium oxide or yellow iron oxide is coated; a coated laminar inorganic crystal substrate such as barium sulfate, layered silicate, or silicate of layered aluminum; single crystal plate-shaped titanium oxide; basic carbonate; acid bismuth oxychloride; natural guanine; laminar glass powder; and laminar glass powder which is subjected to metal vapor deposition, and there is no particular limitation as long as the brilliance is obtained.

Among the brilliant pigments, the metal powder is preferable and aluminum is most preferable among these, particularly from a viewpoint of mirror reflection intensity. The shape of the brilliant pigment is preferably a flake shape.

An average length of the brilliant pigment in the long axis direction is preferably from 1 μm to 30 μm, more preferably from 3 μm to 20 μm, and even more preferably from 5 μm to 15 μm.

A rate (aspect ratio) of the average length in the long axis direction when the average length of the brilliant pigment in the thickness direction is set as 1, is preferably from 5 to 200, more preferably from 10 to 100, and even more preferably from 30 to 70.

The average length in the long axis direction and the aspect ratio of the brilliant pigment are measured with the following method. A photograph of the pigment particles is captured by using a scanning electron microscope (S-4800 manufactured by Hitachi High-Technologies Corporation) with measurable magnification power (300 to 100,000), a length of each particle in the long axis direction and a length thereof in a thickness direction are measured in a two-dimensional state of the obtained image of the pigment particle, and the average length in the long axis direction and the aspect ratio of the brilliant pigment are calculated.

A content of the brilliant pigment is preferably from 1 part by weight to 50 parts by weight and more preferably from 15 parts by weight to 25 parts by weight, with respect to 100 parts by weight of the toner particles.

Hollow Particles and Porous Particles

The hollow particles and the porous particles function as a relative dielectric constant adjusting agent for adjusting the relative dielectric constant of the toner particles. The toner particles contain at least one of the hollow particles and the porous particles.

The hollow particles are particles including one or more hollow parts (voids) therein. As the hollow particles, inorganic hollow particles having a wall material configured with an inorganic material, or organic hollow particles having a wall material configured with an organic material are used.

The porous particles are particles including plural fine holes therein. As the porous particles, the inorganic porous particles and the organic porous particles are used.

Examples of the material of the inorganic hollow particles and the inorganic porous particles include a well-known material such as silica, alumina, titania, calcium carbonate, or zinc oxide.

Examples of the material of the organic hollow particles and the organic porous particles include a polystyrene resin, a polyacrylic resin, a polymethacrylic resin, a polyester resin, a polyvinyl chloride resin, a polyolefin resin, a polyamide resin, a polycarbonate resin, a copolymerized resin of these, or a mixed resin of these. The organic hollow particles and the organic porous particles may be non-crosslinked resin particles or may be crosslinked resin particles.

A number average particle size of the hollow particles and the porous particles is, for example, preferably from 50 nm to 500 nm and more preferably from 100 nm to 400 nm, in order to prevent a decrease in a toner property and to decrease the relative dielectric constant of the toner particles with a small amount.

A void ratio of the hollow particles and the porous particles is, for example, preferably from 10% to 60% and more preferably from 20% to 50%, in order to decrease the relative dielectric constant of the toner particles with a small amount.

The number average particle size and the void ratio of the hollow particles and the porous particles are values measured with the following method. The hollow particles and the porous particles are diluted with ethanol, this diluted material is dried on a carbon grid for a transmission electron microscope (TEM), TEM observation is performed, and the image thereof is printed to extract 50 samples by setting a primary particle as a sample, and thus an outer diameter (diameter) of the circular particle corresponding to the image area is set as the number average particle size of the hollow particles and the porous particles. An inner diameter of the void in the particle is extracted in the same manner as described above, the total value of the cube of the inner diameter of one or plural inner void in one particle is divided by the cube of the number average particle size, and the value multiplied by 100 is set as the void ratio of the hollow particles and the porous particles.

The content of the hollow particles and the porous particles (content of the entirety of particles) is preferably from 5 parts by weight to 40 parts by weight and more preferably from 10 parts by weight to 30 parts by weight, with respect to 100 parts by weight of the toner particles.

Release Agent

Examples of the release agent include hydrocarbon-based waxes; natural waxes such as carnauba wax, rice wax, and candelilla wax; synthetic or mineral/petroleum-based waxes such as montan wax; and ester-based waxes such as fatty acid esters and montanic acid esters. The release agent is not limited thereto.

The melting temperature of the release agent is preferably from 50° C. to 110° C., and more preferably from 60° C. to 100° C.

The melting temperature is obtained from “melting peak temperature” described in the method of obtaining a melting temperature in JIS K7121−1987 “Testing methods for transition temperatures of plastics”, from a DSC curve obtained by differential scanning calorimetry (DSC).

The content of the release agent is, for example, preferably from 1% by weight to 20% by weight, and more preferably from 5% by weight to 15% by weight with respect to the entirety of toner particles.

Other Additives

Examples of other additives include known additives such as a magnetic material, a charge-controlling agent, and an inorganic powder. The toner particles include these additives as internal additives.

Characteristics of Toner Particles

The toner particles may be toner particles having a single-layer structure, or toner particles having a so-called core/shell structure composed of a core (core particle) and a coating layer (shell layer) coated on the core.

Here, toner particles having a core/shell structure is preferably composed of, for example, a core containing a binder resin, a brilliant pigment, and if necessary, hollow particles, porous particles, and other additives such as a release agent, and a coating layer containing a binder resin.

Average Maximum Thickness C and Average Equivalent Circle Diameter D of Toner Particles

As shown in the requirement (1) described above, the toner particles have a flake shape and the average equivalent circle diameter D is preferably longer than the average maximum thickness C. A ratio (C/D) of the average maximum thickness C and the average equivalent circle diameter D is more preferably in a range of 0.001 to 0.500, even more preferably in a range of 0.010 to 0.200, and particularly preferably in a range of 0.050 to 0.100.

When the ratio (C/D) is 0.001 or greater, toner strength is secured and a fracture that is caused due to a stress in the image formation is thus prevented, whereby a reduction in charges that is caused by exposure of the pigment, and fogging that is caused as a result thereof are prevented. Meanwhile, when the ratio (C/D) is equal to or smaller than 0.500, excellent brilliance is obtained.

The average maximum thickness C and the average equivalent circle diameter D are measured with the following method.

The toner particles are applied to a smooth surface and evenly dispersed with vibration. 1000 toner particles are enlarged with a color laser microscope “VK-9700” (manufactured by Keyence Corporation) with a magnification power of 1000, the maximum thickness C and the equivalent circle diameter D of a top view of the brilliant toner particles are measured, and arithmetic average values are calculated to acquire the average maximum thickness C and the average equivalent circle diameter D.

Angle between Long Axis Direction of Toner Particles in Cross Section and Long Axis Direction of Brilliant Pigment Particles

As shown in the requirement (2), when cross sections of toner particles in a thickness direction are observed, the rate (based on the number) of the brilliant pigment particles that are present so that an angle between a long axis direction of the toner particles in the cross section and a long axis direction of the brilliant pigment particles is from −30° to +30° is preferably 60% or greater of the total number of brilliant pigment particles that are observed. Furthermore, the rate described above is more preferably from 70% to 95%, and particularly preferably from 80% to 90% of the total number of brilliant pigment particles that are observed.

When the rate described above is equal to or greater than 60%, excellent brilliance is obtained.

Herein, the observation method of the cross sections of toner particles will be described. A preparation method of the observation samples is the same as the “method of observing the cross section of each toner particle to confirm whether or not the brilliant pigment is contained and whether or not the black colorant is contained in the entirety of toner particles”.

The cross section of the toner particle is observed by using the observation sample obtained with the method described above with a magnification power of approximately 5000 with a transmission electron microscope (TEM) . With the observed 1000 toner particles, the number of brilliant pigments that are present so that the angle between the long axis direction of the toner particles in the cross section and the long axis direction of the brilliant pigment is from −30° C. to +30° C., is counted using image analysis software, and the proportion thereof is calculated.

The “long axis direction of the toner particles in the cross section” indicates a direction perpendicular to the thickness direction of the toner particles having the average equivalent circle diameter D larger than the average maximum thickness C. The “long axis direction of the brilliant pigment particle” indicates a length direction of the brilliant pigment particle.

The volume average particle size of the toner particles is preferably from 1 μm to 30 μm, and more preferably from 3 μm to 20 μm.

The volume average particle size D₅₀ᵥ of the toner particles is acquired by drawing cumulative distributions by volume and by number, respectively, from the side of the smallest size on the basis of particle size ranges (channels) separated based on the particle size distribution measured by a measuring machine such as a Multisizer II (manufactured by Beckman Coulter Inc.). The particle size when the cumulative percentage becomes 16% is defined as that corresponding to a volume D₁₆ᵥ and a number D₁₆ₚ. The particle size when the cumulative percentage becomes 50% is defined as that corresponding to a volume D₅₀ᵥ and a number D₅₀ₚ, and the particle size when the cumulative percentage becomes 84% is defined as that corresponding to a volume D₈₄ᵥ and a number D₈₄ₚ. Using these, a volume average particle size distribution index (GSDv) is calculated as (D₈₄ᵥ/D₁₆ᵥ)^{1/2}.

External Additive

Examples of the external additive include inorganic particles. Examples of the inorganic particles include SiO₂, TiO₂, Al₂O₃, CuO, ZnO, SnO₂, CeO₂ Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, MgSO₄, and the like.

Surfaces of the inorganic particles used as the external additive are preferably subjected to a hydrophobizing treatment. The hydrophobizing treatment is performed by, for example, dipping the inorganic particles in a hydrophobizing agent. The hydrophobizing agent is not particularly limited and examples thereof include a silane coupling agent, silicone oil, a titanate coupling agent, and an aluminum coupling agent. These may be used alone or in combination of two or more kinds thereof.

Generally, the amount of the hydrophobizing agent is, for example, from 1 part by weight to 10 parts by weight with respect to 100 parts by weight of the inorganic particles.

Examples of the external additive also include resin particles (resin particles such as polystyrene, PMMA, and melamine resin) and a cleaning activator (e.g., metal salt of higher fatty acid represented by zinc stearate, and fluorine-based polymer particles).

The externally added amount of the external additive is, for example, preferably from 0.01% by weight to 5% by weight and more preferably from 0.01% by weight to 2.0% by weight, with respect to the toner particles.

Toner Preparing Method

Next, a method of preparing a toner according to the exemplary embodiment will be described.

The toner according to the exemplary embodiment is obtained by externally adding an external additive to toner particles after preparing of the toner particles.

The method of preparing toner particles is not particularly limited, and toner particles are prepared by a known method such as a dry method, e.g., a kneading and pulverizing method or a wet method, e.g., an emulsion aggregating method and a dissolution and suspension method.

The kneading and pulverizing method is a method of mixing each material such as the binder resin, the brilliant pigment, and the like and then melting and kneading the material using a kneader or an extruder, performing coarse pulverizing of the obtained melted and kneaded material, and then performing pulverization using a jet mill, and obtaining toner particles having a particle diameter in a target range by a wind classifier.

In more detail, the kneading and pulverizing method is divided into a kneading step of kneading a toner forming material including a material including the binder resin, the brilliant pigment, and if necessary, the hollow particles, the porous particles, and the other additives such the release agent, and a pulverization step of pulverizing the kneaded material. If necessary, the method may include a cooling step of cooling the kneaded material formed in the kneading step, or another step.

The dissolution and suspension method is a method of obtaining toner particles including: subjecting a liquid in which a material containing the binder resin, the brilliant pigment, and if necessary, the hollow particles, the porous particles, and the other additives such as the release agent is dissolved or dispersed in a solvent in which the binder resin is soluble to granulation in an inorganic dispersant-containing aqueous medium; and removing the solvent.

An emulsion aggregating method may be used in which the shape and the particle diameter of toner particles are easily controlled and the control range in the structure of toner particles such as a core-shell structure is also wide. Hereinafter, a method of preparing toner particles using an emulsion aggregating method will be described in detail.

The emulsion aggregating method has an emulsification step of forming resin particles (emulsification particles) or the like by emulsifying raw materials constituting the toner particles, an aggregation step of forming aggregates of the resin particles, and a coalescence step of coalescing the aggregates.

The emulsion aggregating method has an emulsification step of forming resin particles (emulsification particles) or the like by emulsifying raw materials constituting the toner particles, an aggregation step of forming aggregates of the resin particles and the brilliant pigment, and a coalescence step of coalescing the aggregates. In a case where at least one of the hollow particles and the porous particles is contained in the toner particles, the dispersion of the particles is prepared, and aggregates of the resin particles and the brilliant pigment, and at least one of the hollow particles and the porous particles are formed in the aggregation step.

Emulsification Step

A resin particle dispersion may be prepared using a general polymerization method such as an emulsion polymerization method, a suspension polymerization method, or a dispersion polymerization method. Otherwise, a resin particle dispersion may be prepared through emulsification by applying a shear force to a solution obtained by mixing an aqueous medium with a binder resin using a dispersing machine. In this case, particles may be formed by reducing the viscosity of the resin component by heating. In addition, a dispersant may be used in order to stabilize the dispersed resin particles . Furthermore, when a resin is dissolved in an oily solvent having a relatively low solubility to water, the resin is dissolved in the solvent so that particles thereof are dispersed in the water together with a dispersant or a polyelectrolyte, and then heating or decompression is performed to evaporate the solvent, thereby preparing a resin particle dispersion.

Examples of the aqueous medium include water such as distilled water and ion exchange water; and alcohols. Water is preferably used.

Examples of the dispersant that is used in the emulsification step include water-soluble polymers such as polyvinyl alcohol, methyl cellulose, ethyl cellulose, hydroxyethyl cellulose, carboxymethyl cellulose, sodium polyacrylate, and sodium polymethacrylate; surfactants such as anionic surfactants, e.g., sodium dodecylbenzenesulfonate, sodium octadecylsulfate, sodium oleate, sodium laurate, and potassium stearate, cationic surfactants, e.g., laurylamine acetate, stearyl amine acetate, and lauryl trimethyl ammonium chloride, zwitterionic surfactants, e.g., lauryl dimethyl amine oxide, and nonionic surfactants, e.g., polyoxyethylene alkyl ether, polyoxyethylene alkyl phenyl ether, and polyoxyethylene alkylamine; and inorganic salts such as tricalcium phosphate, aluminum hydroxide, calcium sulfate, calcium carbonate, and barium carbonate.

Examples of the dispersing machine that is used in the preparation of the emulsified liquid include a homogenizer, a homomixer, a pressure kneader, an extruder, and a media-dispersing machine. The size of the resin particles is preferably 1.0 μm or less, more preferably from 60 nm to 300 nm, and even more preferably from 150 nm to 250 nm in terms of the average particle size (volume average particle size). When the size is 60 nm or greater, the resin particles easily become unstable in the dispersion, and thus the resin particles may easily aggregate. When the size is 1.0 μm or less, the particle size distribution of the toner may be narrowed.

In the preparation of a release agent dispersion, a release agent is dispersed in water, together with an ionic surfactant or a polyelectrolyte such as a polymer acid or a polymer base, and then a dispersion treatment is performed using a homogenizer or a pressure discharge-type dispersing machine with which a strong shear force is applied, simultaneously with heating at a temperature that is not lower than the melting temperature of the release agent. A release agent dispersion is obtained through such a treatment. In the dispersion treatment, an inorganic compound such as polyaluminum chloride may be added to the dispersion. Examples of the preferable inorganic compound include polyaluminum chloride, aluminum sulfate, highly basic polyaluminum chloride (BAC), polyaluminum hydroxide, and aluminum chloride. Among these, polyaluminum chloride, aluminum sulfate, and the like are preferable.

Through the dispersion treatment, a release agent dispersion containing release agent particles having a volume average particle size of 1 μm or less is obtained. More preferably, the volume average particle size of the release agent particles is from 100 nm to 500 nm.

When the volume average particle size is 100 nm or greater, although it is also affected by the characteristics of the binder resin to be used, generally, the release agent component is easily incorporated in the toner. When the volume average particle size is 500 nm or less, the release agent in the toner has a superior dispersion state.

In order to prepare a brilliant pigment dispersion, a known dispersion method may be used and a general dispersion unit such as a rotary shearing-type homogenizer, a ball mill having media, a sand mill, a Dyno mill, or an Ultimizer may be employed, but there are no limitation for the dispersion unit. The brilliant pigment is dispersed in water, together with an ionic surfactant or a polyelectrolyte such as a polymer acid or a polymer base. The volume average particle size of the dispersed brilliant pigment may be 20 μm or less. The volume average particle size is preferably from 3 μm to 16 μm, since the brilliant pigment is dispersed well in the toner particles with no impairment in aggregability.

In addition, a brilliant pigment and a binder resin may be dispersed and dissolved in a solvent to be mixed with each other, and dispersed in the water by phase inversion emulsification or shearing emulsification, thereby preparing a dispersion of brilliant pigment coated with the binder resin.

In the preparation of a hollow particle dispersion and a porous particle dispersion, the well-known dispersion method may also be used, and there are no limitation therefor.

Aggregation Step

In the aggregation step, a resin particle dispersion, a brilliant pigment dispersion, and if necessary, other dispersion such as a hollow particle dispersion, a porous particle dispersion, and a release agent dispersion are mixed to prepare a mixture, and heated at a temperature that is not higher than the glass transition temperature of the resin particles for aggregation, thereby forming aggregated particles. In many cases, in order to form the aggregated particles, the pH of the mixture is adjusted to acidic under stirring. By virtue of the above stirring conditions, the ratio (C/D) may be adjusted in a preferable range. More specifically, in the aggregated particle forming stage, when rapid stirring and heating are performed, the ratio (C/D) may be reduced, and when the stirring speed is reduced and the heating is performed at lower temperature, the ratio (C/D) may be increased. The pH is preferably from 2 to 7, at which an aggregating agent may also be effectively used.

Furthermore, in the aggregation step, the hollow particle dispersion or the porous particle dispersion is preferably added together with various dispersions such as a resin particle dispersion in several times, and this is preferable since uneven distribution of the hollow particles or the porous particles in the toner may be reduced. This is because the order of formation of the aggregated particles is generally different since the charging in each dispersion is different.

As the aggregating agent, a di- or higher-valent metal complex is preferably used, as well as a surfactant having an opposite polarity to the polarity of the surfactant that is used as the dispersant, and an inorganic metal salt. Since the amount of the surfactant to be used may be reduced and the charging characteristics are improved, a metal complex is particularly preferably used.

As the inorganic metal salt, aluminum salts and polymers thereof are particularly preferable. In order to obtain a narrower particle size distribution, the valence of the inorganic metal salt is more preferably divalent than monovalent, trivalent than divalent, and tetravalent than trivalent, and further, in the case of the same valences as each other, a polymer-type inorganic metal salt polymer is more suitable.

In the exemplary embodiment, a polymer of tetravalent inorganic metal salt including aluminum is preferably used to obtain a narrow particle size distribution.

In addition, when the aggregated particles have a desired particle size, the resin particle dispersion may be further added (coating step) to prepare a toner having a configuration in which a surface of a core aggregated particle is coated with a resin. In this case, the release agent or the brilliant pigment is not easily exposed to the toner surface, and thus the configuration is preferable from the viewpoint of charging properties or developability. In the case of further addition, an aggregating agent may be added or the pH may be adjusted before further addition.

Coalescence Step

In the coalescence step, the progression of the aggregation is stopped by increasing the pH of the suspension of the aggregated particles to the range of 3 to 9 under stirring conditions based on those in the aggregation step, and the aggregated particles are coalesced by heating at a temperature that is not lower than the glass transition temperature of the resin.

In addition, in the case of coating with the resin, the resin is also coalesced and the core aggregated particles are coated therewith. Regarding the heating time, the heating may be performed to the extent that the coalescence is caused, and may be performed for, approximately, 0.5 hour to 10 hours.

After coalescence, cooling is performed to obtain coalesced particles. In addition, in the cooling step, crystallization may be promoted by lowering the cooling rate at around the glass transition temperature of the resin (glass transition temperature±10° C.), that is, so-called slow cooling.

The coalesced particles obtained by coalescence are subjected to a solid-liquid separation step such as filtration, and if necessary, a washing step and a drying step, and thus toner particles are obtained.

The toner according to the exemplary embodiment is manufactured by, for example, adding and mixing the external additives with dry toner particles that have been obtained. The mixing is preferably performed with, for example, a V-blender, a Henschel mixer, a Lödige mixer, or the like. Furthermore, if necessary, coarse toner particles may be removed using a vibration sieving machine, a wind classifier, or the like.

Electrostatic Charge Image Developer

An electrostatic charge image developer according to the exemplary embodiment includes at least the toner according to the exemplary embodiment.

The electrostatic charge image developer according to the exemplary embodiment may be a single-component developer including only the toner according to the exemplary embodiment, or a two-component developer obtained by mixing the toner with a carrier.

The carrier is not particularly limited, and known carriers are exemplified. Examples of the carrier include a coated carrier in which surfaces of cores formed of a magnetic powder are coated with a coating resin; a magnetic powder dispersion-type carrier in which a magnetic powder is dispersed and blended in a matrix resin; a resin impregnation-type carrier in which a porous magnetic powder is impregnated with a resin; and a resin dispersion-type carrier in which conductive particles are dispersed and blended in a matrix resin.

The magnetic powder dispersion-type carrier and the resin impregnation-type carrier may be carriers in which constituent particles of the carrier are cores and coated with a coating resin.

Examples of the magnetic powder include magnetic metal such as iron, nickel, cobalt, and the like, and magnetic oxide such as ferrite, magnetite, and the like.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin configured to include an organosiloxane bond or a modified product thereof, a fluorine resin, polyester, polycarbonate, a phenol resin, and an epoxy resin.

The coating resin and the matrix resin may contain other additives such as conductive particles. Examples of the conductive particles include particles of metals such as gold, silver, and copper, carbon black particles, titanium oxide particles, zinc oxide particles, tin oxide particles, barium sulfate particles, aluminum borate particles, and potassium titanate particles.

Here, a coating method using a coating layer forming solution in which a coating resin, and if necessary, various additives are dissolved in an appropriate solvent is used to coat the surface of a core with the coating resin. The solvent is not particularly limited, and may be selected in consideration of the coating resin to be used, coating suitability, and the like.

Specific examples of the resin coating method include a dipping method of dipping cores in a coating layer forming solution, a spraying method of spraying a coating layer forming solution to surfaces of cores, a fluid bed method of spraying a coating layer forming solution in a state in which cores are allowed to float by flowing air, and a kneader-coater method in which cores of a carrier and a coating layer forming solution are mixed with each other in a kneader-coater and the solvent is removed.

The mixing ratio (mass ratio) between the toner and the carrier in the two-component developer is preferably from 1:100 to 30:100 (toner:carrier), and more preferably from 3:100 to 20:100.

Image Forming Apparatus and Image Forming Method

An image forming apparatus and an image forming method according to the exemplary embodiment will be described.

The image forming apparatus according to the exemplary embodiment is provided with an image holding member, a charging unit that charges a surface of the image holding member, an electrostatic charge image forming unit that forms an electrostatic charge image on a charged surface of the image holding member, a developing unit that contains an electrostatic charge image developer and develops the electrostatic charge image formed on the surface of the image holding member with the electrostatic charge image developer to forma toner image, a transfer unit that transfers the toner image formed on the surface of the image holding member onto a surface of a recording medium, and a fixing unit that fixes the toner image transferred onto the surface of the recording medium. As the electrostatic charge image developer, the electrostatic charge image developer according to the exemplary embodiment is applied.

In the image forming apparatus according to the exemplary embodiment, an image forming method (image forming method according to the exemplary embodiment) including a charging step of charging a surface of an image holding member, an electrostatic charge image forming step of forming an electrostatic charge image on a charged surface of the image holding member, a developing step of developing the electrostatic charge image formed on the surface of the image holding member with the electrostatic charge image developer according to the exemplary embodiment to form a toner image, a transfer step of transferring the toner image formed on the surface of the image holding member onto a surface of a recording medium, and a fixing step of fixing the toner image transferred onto the surface of the recording medium is performed.

As the image forming apparatus according to the exemplary embodiment, a known image forming apparatus is applied, such as a direct transfer-type apparatus that directly transfers a toner image formed on a surface of an image holding member onto a recording medium; an intermediate transfer-type apparatus that primarily transfers a toner image formed on a surface of an image holding member onto a surface of an intermediate transfer member, and secondarily transfers the toner image transferred onto the surface of the intermediate transfer member onto a surface of a recording medium; an apparatus that is provided with a cleaning unit that cleans, after transfer of a toner image, a surface of an image holding member before charging; or an apparatus that is provided with an erasing unit that irradiates, after transfer of a toner image, a surface of an image holding member with erasing light before charging to perform erasing.

In the case of an intermediate transfer-type apparatus, a transfer unit is configured to have, for example, an intermediate transfer member having a surface onto which a toner image is to be transferred, a primary transfer unit that primarily transfers a toner image formed on a surface of an image holding member onto the surface of the intermediate transfer member, and a secondary transfer unit that secondarily transfers the toner image transferred onto the surface of the intermediate transfer member onto a surface of a recording medium.

In the image forming apparatus according to the exemplary embodiment, for example, a part including the developing unit may have a cartridge structure (process cartridge) that is detachable from the image forming apparatus. As the process cartridge, for example, a process cartridge that accommodates the electrostatic charge image developer according to the exemplary embodiment and is provided with a developing unit is preferably used.

Hereinafter, an example of the image forming apparatus according to the exemplary embodiment will be described, but there is no limitation thereto. Major parts shown in the drawings will be described, but descriptions of other parts will be omitted.

FIG. 2 is a schematic configuration diagram showing an example of the image forming apparatus according to the exemplary embodiment including a developing device using the electrostatic charge image developer according to the exemplary embodiment.

In the drawing, the image forming apparatus according to the exemplary embodiment includes a photoreceptor 20 as an image holding member which rotates in a predetermined direction, and around this photoreceptor 20, a charging device 21 (an example of the charging unit) which charges the photoreceptor 20 (an example of the image holding member), an exposure device 22 (an example of the electrostatic charge image forming unit), for example, as an electrostatic charge image forming device which forms an electrostatic charge image Z on the photoreceptor 20, a developing device 30 (an example of the developing unit) which visualizes the electrostatic charge image Z formed on the photoreceptor 20, a transfer device 24 (an example of the transfer unit) which transfers a toner image which is visualized on the photoreceptor 20 to a recording sheet 28 which is a recording medium, and a cleaning device 25 (an example of the cleaning unit) which cleans toner remaining on the photoreceptor 20 are disposed in order.

In the exemplary embodiment, as shown in FIG. 2, the developing device 30 has a developing container 31 that accommodates a developer G including a toner 40. This developing container 31 has a developing opening 32 formed to be opposed to the photoreceptor 20, and a developing roll (developing electrode) 33 as a toner holding member arranged to face the developing opening 32. When a predetermined developing bias is applied to the developing roll 33, a developing electric field is formed in a region (developing region) sandwiched between the photoreceptor 20 and the developing roll 33. In the developing container 31, a charge injection roll (injection electrode) 34 as a charge injection member is provided to be opposed to the developing roll 33. Particularly, in the exemplary embodiment, the charge injection roll 34 also acts as a toner supply roll for supplying the toner 40 to the developing roll 33.

Herein, the charge injection roll 34 may be rotated in an arbitrarily selected direction, but in consideration of supply properties of the toner and charge injection properties, it is preferable that the charge injection roll 34 be rotated in the same direction as that of the developing roll 33 at a part opposed to the developing roll 33 with a difference in the peripheral velocity (for example, 1.5 times or greater), and the toner 40 be interposed in a region sandwiched between the charge injection roll 34 and the developing roll 33 and be rubbed to inject charges.

Next, an operation of the image forming apparatus according to the exemplary embodiment will be described.

When an image forming process is started, first, the surface of the photoreceptor 20 is charged by the charging device 21, the exposure device 22 forms an electrostatic charge image Z on the charged photoreceptor 20, and the developing device 30 visualizes the electrostatic charge image Z as a toner image. Then, the toner image on the photoreceptor 20 is transported to a transfer site, and the transfer device 24 electrostatically transfers the toner image on the photoreceptor 20 onto a recording sheet 28 as a recording medium. The toner remaining on the photoreceptor 20 is cleaned by the cleaning device 25. Thereafter, the toner image on the recording sheet 28 is fixed by a fixing device 36 (an example of the fixing unit) to obtain an image.

Process Cartridge/Toner Cartridge

A process cartridge according to the exemplary embodiment will be described.

The process cartridge according to the exemplary embodiment is a process cartridge which includes a developing unit which accommodates the electrostatic charge image developer according to the exemplary embodiment and develops an electrostatic charge image formed on a surface of an image holding member as a toner image by the electrostatic charge image developer, and is detachable from the image forming apparatus.

Without being limited to the configuration described above, the process cartridge according to the exemplary embodiment may have a configuration including a developing device and, if necessary, at least one selected from other units such as the image holding member, the charging unit, an electrostatic charge image forming unit, and a transfer unit.

Hereinafter, an example of the process cartridge according to the exemplary embodiment will be shown. However, there is no limitation thereto. Major parts shown in the drawings will be described, but descriptions of other parts will be omitted.

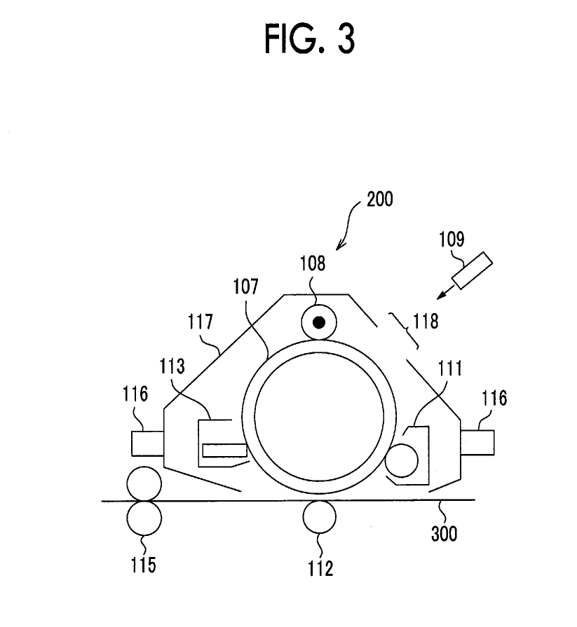

FIG. 3 is a schematic configuration diagram showing the process cartridge according to the exemplary embodiment.

A process cartridge 200 shown in FIG. 3 is, for example, configured by integrally combining and holding a photoreceptor 107 (an example of image holding member), a charging roll 108 (an example of charging unit), a developing device 111 (an example of developing unit), and a photoreceptor cleaning device 113 (an example of cleaning unit) which are provided around the photoreceptor 107 by attachment rails 116 and a housing 117 with an opening portion 118 for exposure, and is configured as a cartridge.

In FIG. 2, reference numeral 109 denotes an exposing device (an example of electrostatic charge image forming unit), reference numeral 112 denotes a transfer device (an example of transfer unit), reference numeral 115 denotes a fixing device (an example of fixing unit), and reference numeral 300 denotes a recording sheet (an example of recording medium).

Next, a toner cartridge according to the exemplary embodiment will be described. The toner cartridge according to the exemplary embodiment may be configured so as to accommodate the brilliant toner according to the exemplary embodiment and to be detachable from the image forming apparatus. At least the toner may be accommodated in the toner cartridge according to the exemplary embodiment, and a developer, for example, maybe accommodated therein, depending on a mechanism of the image forming apparatus.

The image forming apparatus shown in FIG. 2 has a configuration in which a toner cartridge (not shown) is detachably mounted thereon, and the developing device 30 is connected to the toner cartridge via a toner supply tube (not shown) . In addition, when the toner contained in the toner cartridge runs low, the toner cartridge may be replaced.

### Examples

Hereinafter, the exemplary embodiment will be described in more detail using examples, but is not limited to the following examples. Unless otherwise noted, “parts” and “%” are based on weight.

Preparation of Toner

Synthesis of Binder Resin (1)
Dimethyl adipate: 74 parts
Dimethyl terephthalate: 192 parts
Bisphenol A ethylene oxide adduct: 216 parts
Ethylene glycol: 38 parts
Tetrabutoxytitanate (catalyst): 0.037 part

The above components are put in a two-necked flask which is dried by heating, nitrogen gas is introduced in a container to maintain an inert atmosphere, and the components are heated while stirring, and then are subjected to co-condensation polymerization reaction for 7 hours at 160° C., and then a temperature thereof is increased to 220° C. while slowly reducing pressure thereof to 10 Torr and those are maintained for 4 hours. The pressure is temporarily returned to normal pressure, 9 parts of trimellitic anhydride is added, and the pressure thereof is slowly reduced again to 10 Torr and maintained for 1 hours at 220° C., to synthesize the binder resin (1).

The glass transition temperature (Tg) of the binder resin (1) is acquired by measuring under the conditions of a temperature rising rate of 10° C./min from a room temperature (25° C.) to 150° C., using a differential scanning calorimeter (DSC-50 manufactured by Shimadzu Corporation), based on ASTMD 3418−8. The glass transition temperature is set to a temperature at intersection of extended lines of a base line and a rising line in an endothermic portion. The glass transition temperature of the binder resin (1) is 63.5° C.

Preparation of Resin Particle Dispersion (1)
Binder resin (1): 160 parts
Ethyl acetate: 233 parts
Sodium hydroxide aqueous solution (0.3 N): 0.1 part

The above components are put in a 1000 ml separable flask, heated at 70° C., and stirred with Three-One Motor (manufactured by Shinto Scientific Co. , Ltd.) to prepare a resin mixed liquid. The resin mixed liquid is further stirred at 90 rpm, 373 parts of the ion exchange water is slowly added therein to perform phase inversion emulsification, and the solvent thereof is removed to obtain resin particle dispersion (1) (solid content concentration: 30%). A volume average particle size of the resin particles in the resin particle dispersion (1) is 162 mm.

Preparation of Release Agent Dispersion
Carnauba wax (RC-160 manufactured by Toa Kasei Co., Ltd.): 50 parts
Anionic surfactant (NEOGEN RK manufactured by Dai-Ichi Kogyo Seiyaku Co., Ltd.): 1.0 part
Ion exchange water: 200 parts

The above components are mixed with each other and heated at 95° C., dispersed using a homogenizer (ULTRA-TURRAX T50 manufactured by IKA Ltd.), and then are subject to dispersion treatment with Manton-Gaulin high pressure homogenizer (manufactured by Gaulin Co., Ltd.) for 360 minutes, and a release agent dispersion (solid content concentration: 20%) formed by dispersing the release agent particles having the volume average particle size of 0.23 pm is prepared.

Preparation of Brilliant Pigment Particle Dispersion

Preparation of Brilliant Pigment Particle Dispersion (1)
Aluminum pigment (2173EA manufactured by SHOWA ALUMINUM POWDER K.K.): 100 parts
Anionic surfactant (NEOGEN R manufactured by Dai-Ichi Kogyo Seiyaku Co., Ltd.): 1.5 parts
Ion exchange water: 900 parts

After removing a solvent from the paste of the aluminum pigment, the above components are mixed, dissolved, and dispersed for approximately 1 hour using an emulsifying disperser CAVITRON (CR1010 manufactured by Pacific Machinery & Engineering Co., Ltd.), and a brilliant pigment particle dispersion (solid content concentration: 10%) in which the brilliant pigment particles (aluminum pigment) are dispersed is prepared.

Preparation of Hollow Particle Dispersion

Preparation of Hollow Particle Dispersion (1)
Hollow styrene.acrylic copolymer particles (SX866 (A): manufactured by JSR Corporation, number average particle size of 300 nm, dried powder): 40 parts
Anionic surfactant (NEOGEN R manufactured by Dai-Ichi Kogyo Seiyaku Co., Ltd.): 1 part
Ion exchange water: 160 parts

The above components are mixed and dispersed for approximately 1 hour by using an emulsifying disperser CAVITRON (CR1010 manufactured by Pacific Machinery & Engineering Co., Ltd.), and a hollow particle dispersion (1) (solid content concentration: 20%) is prepared.

Preparation of Hollow Particle Dispersion (2)
Hollow silica particles (SiliNax: manufactured by Nittetsu Mining Co., Ltd., number average particle size of 100 nm, dried powder): 40 parts
Anionic surfactant (NEOGEN R manufactured by Dai-Ichi Kogyo Seiyaku Co., Ltd.): 1 part
Ion exchange water: 160 parts

The above components are mixed and dispersed for approximately 1 hour by using an emulsifying disperser CAVITRON (CR1010 manufactured by Pacific Machinery & Engineering Co., Ltd.), and a hollow particle dispersion (2) (solid content concentration: 20%) is prepared.

Preparation of Porous Particle Dispersion

Preparation of Porous Particle Dispersion (1)
Porous particles (LA-0S253M: manufactured by Nissan Chemical Industries, Ltd., number average particle size of 100 nm, methanol dispersion element (solid content concentration: 25%)): 160 parts
Anionic surfactant (NEOGEN R manufactured by Dai-Ichi Kogyo Seiyaku Co., Ltd.): 1 part
Ion exchange water: 160 parts

After removing a solvent from methanol dispersion of the porous particles, the above components are mixed and dispersed for approximately 1 hour by using an emulsifying disperser CAVITRON (CR1010 manufactured by Pacific Machinery & Engineering Co., Ltd.), and a hollow particle dispersion (2) (solid content concentration: 20%) is prepared.

### Examples

Preparation of Toner 1
Resin particle dispersion: 250 parts
Release agent dispersion: 50 parts
Brilliant pigment particle dispersion (1): 320 parts
Hollow particle dispersion (1): 100 parts
Nonionic surfactant (IGEPAL CA897): 1.40 parts

The above raw materials are put in a 2L cylindrical stainless container, dispersed and mixed for 10 minutes while applying a shear force at 4000 rpm using a homogenizer (ULTRA-TURRAX T50 manufactured by IKA Ltd.). Then, 1.75 parts of 10% nitric acid aqueous solution of polyaluminum chloride is slowly added dropwise as an aggregating agent, the resultant material is dispersed and mixed for 15 minutes by setting a rotating speed of the homogenizer to 5000 rpm, and is set to a raw material dispersion.

After that, the raw material dispersion is put in a polymerization tank including a stirring device using stirring blades of two paddles and a thermometer, heating is started with a mantle heater by setting a stirring rotation speed to 810 rpm, and growth of aggregated particles is promoted at 54° C. At that time, pH of the raw material dispersion is controlled to be in a range of 2.2 to 3.5 with 0.3 N nitric acid and 1 N sodium hydroxide aqueous solution. The raw material dispersion is maintained in the pH range described above for about 2 hours and the aggregated particles are formed.

Next, a mixed solution obtained by mixing 50 parts of the resin particle dispersion and 100 parts of the hollow particle dispersion (1) with each other, is added and the resin particles of the binder resin are attached to the surface of the aggregated particles. In addition, the temperature thereof is increased to 56° C., the aggregated particles are prepared while confirming the size and form of the particle with an optical microscope and Multisizer II. Then, after increasing pH to 8.0 for coalescing the aggregated particles, the temperature thereof is increased to 67.5° C. After confirming that the aggregated particles are coalesced with the optical microscope, pH thereof is decreased to 6.0 while maintaining the temperature at 67.5° C., the heating is stopped after 1 hour, and cooling is performed at a temperature falling rate of 1.0° C./min. Then, after performing sieving with mesh of 20 μm and repeating water washing, the resultant material is dried with a vacuum drying machine to obtain toner particles. The volume average particle size of the obtained toner particles is 12.2 μm. In addition, it is confirmed that the toner particles have a flake shape and the average equivalent circle diameter D thereof is larger than the average maximum thickness C thereof.

2.0 parts of hydrophobic silica (RY50 manufactured by Nippon Aerosil Co., Ltd.) is mixed with respect to 100 parts of the obtained toner particles using the Henschel mixer at the peripheral velocity of 30 m/s for 3 minutes. Then, sieving is performed with a vibration screen with an aperture of 45 μm, to prepare toner 1.

Preparation of Carrier
Ferrite particles (volume average particle size: 35 μm): 100 parts
Toluene: 14 parts
Perfluoroacrylate copolymer (critical surface tension: 24 dyn/cm): 1.6 parts
Carbon black (product name: VXC-72 manufactured by Cabot Corporation, volume resistivity: 100 Ωcm or lower): 0.12 part
Crosslinked melamine resin particles (average particle size: 0.3 μm, toluene-insoluble): 0.3 part

First, carbon black diluted with toluene is added to the perfluoroacrylate copolymer and the obtained material is dispersed with a sand mill. Then, each component other than the ferrite particles is dispersed therein with a stirrer for 10 minutes, and a coating layer forming solution is prepared. Then, after putting the coating layer forming solution and the ferrite particles in a vacuum deaeration type kneader and stirring for 30 minutes at a temperature of 60° C., the pressure is reduced and toluene is distilled to form a resin coating layer and obtain a carrier.

Preparation of Developer

36 parts of the toner and 414 parts of the carrier are put in 2 liter V-blender, stirred for 20 minutes, and then sieved with mesh of 212 μm to prepare a developer.

Toners 2 to 6 and Comparative Toners 1 to 2

Toners and developers are prepared in the same manner as in Example 1, except for using the brilliant pigment particle dispersion and the hollow particle dispersion or the porous particle dispersion according to Table 1, in amounts based on Table 1.

50% by weight of the hollow particle dispersion or the porous particle dispersion of the amount disclosed in Table 1 is first put in a 2L cylindrical stainless container with the brilliant pigment particle dispersion. The remaining 50% by weight thereof is mixed with 50 parts of the resin particle dispersion to grow the aggregated particles, and then the mixture is added thereto.

Evaluation Test

Measurement of Relative Dielectric Constant

The relative dielectric constant of the toner particles of the toner of the developer obtained in each example is measured with the method described above.

When the relative dielectric constant of the toner itself is measured, it is confirmed that a value thereof is substantially the same as the relative dielectric constant of the toner particles after removing the external additive from the toner.

Formation of Solid Image

A solid image is formed with the following method.

A developing device of a DocuCentre-III 07600 manufactured by Fuji Xerox Co., Ltd. is filled with the developer obtained in each example, and a solid image having the toner applied amount of 4.5 g/cm² is formed on a recording sheet (OK Top Coat+ (plus), manufactured by Oji Paper Co., Ltd.) at a fixing temperature of 190° C. and fixing pressure of 4.0 kg/cm². The “solid image” indicates an image having a coverage rate of 100%.

Measurement of Ratio (A/B)

The incident light at an angle of incidence of −45° with respect to the solid image is applied to an image portion of the formed solid image, and a reflectance A at a light receiving angle of +30° and a reflectance B at a light receiving angle of −30° are measured by using a variable angle photometer GC5000L as a goniophotometer manufactured by Nippon Denshoku Industries Co., Ltd. Each of the reflectance A and the reflectance B is measured regarding the light having a wavelength of 400 nm to 700 nm at intervals of 20 nm, and defined as an average value of the reflectances at respective wavelengths. The ratio (A/B) is calculated from these measurement results. Results thereof are shown in Table 1.

Evaluation of Toner Scattering

Evaluation of the toner scattering is performed as follows.

A developing device of a modified 700 Digital color press manufactured by Fuji Xerox Co., Ltd. is filled with a developer that is a sample, and the developer is set in a position of a magenta developing device. An image having a stripe shape in a direction orthogonal to a processing direction, which is an image including a brilliant toner layer (toner applied amount of 4.5 g/cm²) formed on a yellow toner layer (toner applied amount of 4.5 g/cm²) is output on a recording sheet (OK Top Coat+ (plus), manufactured by Oji Paper Co., Ltd.) in the environment of a high temperature and high humidity (temperature of 30° C. and humidity of 85%) at a processing speed of 405 mm/s.

A non-image portion around the stripe image is visually observed, and accordingly the evaluation of the toner scattering is performed.

Evaluation criteria are as follows.

A: No toner scattering is observed even when the observation is performed with a magnifier.

B: No toner scattering is visually observed, and toner scattering is observed when the observation is performed with a magnifier.

C: Slight toner scattering is visually observed.

D: Toner scattering is visually observed but it is in an acceptable range.

E: Toner scattering is visually observed and it is not in an acceptable range.

TABLE 1

| | | | | Hollow particle dispersion or porous particle dispersion | | | | | | | |
|---|---|---|---|---|---|---|---|---|---|---|---|
| | Brilliant pigment dispersion | | | | | | | Number | Evaluation | | |
| | | | Content of | | | Content of | | average | Relative | | |
| | | | pigment (% | | | particle (% | Void ratio | particle | dielectric | | |
| | | | with respect | | | with respect | of hollow | size of | constant | | |
| | | Amount of | to toner | | Amount of | to toner | particles | particles | of toner | Ratio | Toner |
| | No. | dispersion | particles) | No. | dispersion | particles) | (%) | (nm) | particles | (A/B) | scattering |
| Ex. 1 | (1) | 320 | 20 | Hollow particle (1) | 200 | 25 | 30 | 300 | 4.1 | 55 | B |
| Ex. 2 | (1) | 230 | 20 | Hollow particle (1) | 40 | 7 | 30 | 300 | 5.8 | 59 | D |
| Ex. 3 | (1) | 390 | 20 | Hollow particle (1) | 380 | 38 | 30 | 300 | 2.2 | 40 | A |
| Ex. 4 | (1) | 320 | 20 | Hollow particle (2) | 200 | 25 | 34 | 100 | 4.3 | 53 | B |
| Ex. 5 | (1) | 320 | 20 | Porous particle (1) | 200 | 25 | 39 | 300 | 3.9 | 52 | B |
| Ex. 6 | (1) | 800 | 37 | Hollow particle (1) | 270 | 25 | 30 | 300 | 5.6 | 80 | D |
| Com. | (1) | 220 | 20 | Hollow particle (1) | 20 | 4 | 30 | 300 | 6.2 | 61 | E |
| Ex. 1 | | | | | | | | | | | |
| Com. | (1) | 420 | 20 | Hollow particle (1) | 440 | 41 | 30 | 300 | 1.9 | 1.8 | A |
| Ex. 2 | | | | | | | | | | | |

From the results described above, it is found that, in the examples, the toner scattering is prevented even when a brilliant pigment is included, compared to the comparative examples.

In addition, it is found that, in the examples, the ratio (A/B) is high and brilliance of the image is high.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A brilliant toner comprising:
toner particles containing a binder resin, a brilliant pigment, and particles selected from hollow particles and porous particles,
wherein a relative dielectric constant of the toner particles is from 2.0 to 6.0.

2. The brilliant toner according to claim 1, wherein a content of the particles selected from hollow particles and porous particles is from 5% by weight to 40% by weight with respect to the toner particles.

3. The brilliant toner according to claim 1, wherein a number average particle size of particles selected from hollow particles and porous particles is in a range of 50 nm to 500 nm.

4. The brilliant toner according to claim 1, wherein a void ratio of the particles selected from hollow particles and porous particles is in a range of 10% to 60%.

5. The brilliant toner according to claim 1, wherein the toner particles have a flake shape.

6. The brilliant toner according to claim 5, wherein a ratio (C/D) of an average maximum thickness C and an average equivalent circle diameter D is in a range of 0.001 to 0.500.

7. The brilliant toner according to claim 1, wherein a relative dielectric constant of the toner particles is from 3.0 to 5.5.

8. An electrostatic charge image developer comprising the brilliant toner according to claim 1.

9. A toner cartridge that accommodates the brilliant toner according to claim 1, and is detachable from an image forming apparatus.

10. A process cartridge comprising:
a developing unit that accommodates the electrostatic charge image developer according to claim 8 and develops an electrostatic charge image formed on a surface of an image holding member with the electrostatic charge image developer as a toner image,
wherein the process cartridge is detachable from an image forming apparatus.
